(19) United States
(12) Patent Application Publication
(10) Pub. No.: US 2013/0027642 A1
(43) Pub. Date: Jan. 31, 2013

(54) OPTICAL FILM, METHOD OF MANUFACTURING THE SAME, AND DISPLAY APPARATUS HAVING THE SAME

(71) Applicants: Nakcho Choi, Hwaseong-si (KR); Hae-ju Yun, Hwaseong-si (KR)

(72) Inventors: Nakcho Choi, Hwaseong-si (KR); Hae-ju Yun, Hwaseong-si (KR)

(21) Appl. No.: 13/369,748

(22) Filed: Feb. 9, 2012

(30) Foreign Application Priority Data
Jul. 26, 2011 (KR) 10-2011-0074168

(51) Int. Cl. G02F 1/1335

(52) U.S. Cl. 349/98; 349/187

(57) ABSTRACT

An optical film includes a base film, thin film patterns, and cholesteric liquid crystals. The thin film patterns are disposed on the base film to be spaced apart from each other and have a first property corresponding to one of a hydrophilic property and a hydrophobic property. The cholesteric liquid crystals have the first property and are disposed on the thin film patterns to transmit one of a right-circularly polarized light and a left-circularly polarized light and reflect the other one of the right-circularly polarized light and the left-circularly polarized light. A display apparatus includes a light source unit emitting a light, a display panel receiving the light and controlling a transmittance of the light to display an image, and an optical film disposed between the light source unit and the display panel.

### CROSS-REFERENCE TO RELATED APPLICATION

This application claims the benefit of Korean Patent Application No. 10-2011-0074168 filed on Jul. 26, 2011, the contents of which are herein incorporated by reference in their entirety.

### BACKGROUND

1. Field of Disclosure

The present invention relates to an optical film, a method of manufacturing the same, and a display apparatus having the same. More particularly, the present invention relates to an optical film capable of increasing the brightness of light provided to a display panel, a method of manufacturing the optical film, and a display apparatus having the same.

2. Description of the Related Art

In general, a liquid crystal display includes a display panel displaying an image with a liquid crystal layer and a backlight unit providing light to the display panel. Since the display panel represents a gray scale using an anisotropic characteristic of liquid crystals included in the liquid crystal layer, the liquid crystal display further includes a linear polarizing plate disposed between the display panel and the backlight unit.

However, the linear polarizing plate transmits about 50% of the light that is not polarized and absorbs about 50% of the light not polarized, so that about 50% of the light provided from the backlight unit is provided to the display panel to be used to display the image. Accordingly, light utilization efficiency of the liquid crystal display is lowered and the liquid crystal display does not to provide the image having a relatively high brightness.

### SUMMARY

Exemplary embodiments of the present invention provide an optical film capable of increasing brightness of the light provided to a display panel.

Other exemplary embodiments of the present invention provide methods of manufacturing the optical film.

Exemplary embodiments of the present invention provide a display apparatus that includes the optical film.

According to certain exemplary embodiments, an optical film includes a base film, a plurality of thin film patterns, and a plurality of cholesteric liquid crystals.

The thin film patterns are disposed on the base film to be spaced apart from each other and have a first property corresponding to one of a hydrophilic property and a hydrophobic property. The cholesteric liquid crystals have the first property and are respectively disposed on the thin film patterns to transmit one of a right-circularly polarized light and a left-circularly polarized light and reflect the other one of the right-circularly polarized light and the left-circularly polarized light.

According to the exemplary embodiments, a display apparatus includes a light source unit emitting a light, a display panel, and an optical film.

The display panel receives the light and controls a transmittance of the light to display an image. The optical film is disposed between the light source unit and the display panel and includes a base film, a plurality of thin film patterns, and a plurality of cholesteric liquid crystals.

The thin film patterns are disposed on the base film to be spaced apart from each other and have a first property corresponding to one of a hydrophilic property and a hydrophobic property. The cholesteric liquid crystals have the first property and are respectively disposed on the thin film patterns to transmit one of a right-circularly polarized light and a left-circularly polarized light and reflect the other one of the right-circularly polarized light and the left-circularly polarized light.

According to the exemplary embodiments, a method of manufacturing an optical film is provided as follows.

A plurality of thin film patterns are formed on a base film to be spaced apart from each other. The thin film patterns each have a first property corresponding to one of a hydrophilic property and a hydrophobic property. Cholesteric liquid crystals are then formed on each of the thin film patterns. The cholesteric liquid crystals initially include a reactive mesogen and represent a blue color. Light is subsequently non-uniformly irradiated onto the cholesteric liquid crystals to change a part of the cholesteric liquid crystals to a red cholesteric liquid crystal representing a red color, or to a green cholesteric liquid crystal representing a green color.

In an optical film manufactured according to the above method, the light provided from the light source unit may be provided to the display panel without loss of the light. Thus, the light utilization efficiency of the display apparatus may be improved, the power consumption in the display apparatus may be reduced, and the display apparatus may provide observers with the image having a high brightness.

### BRIEF DESCRIPTION OF THE DRAWINGS

The above and other advantages of the present invention will become readily apparent by reference to the following detailed description when considered in conjunction with the accompanying drawings wherein:

FIG. 1 is an exploded cross-sectional view showing a display apparatus according to an exemplary embodiment of the present invention;

FIG. 2 is a view showing an optical path of a light in a retardation plate, an optical film, and a reflection plate shown in FIG. 1;

FIG. 3 is an enlarged cross-sectional view showing an E1 area of the optical film shown in FIG. 2 according to an exemplary embodiment of the present invention;

FIG. 4A is a view showing an E2 area of a cholesteric liquid crystal shown in FIG. 3 according to an exemplary embodiment of the present invention;

FIG. 4B is a view showing an area E2 area of a cholesteric liquid crystal shown in FIG. 3 according to another exemplary embodiment of the present invention;

FIG. 5 is an enlarged cross-sectional view showing an E1 area of the optical film shown in FIG. 2 according to another exemplary embodiment of the present invention;

FIG. 6 is an enlarged cross-sectional view showing an E1 area of the optical film shown in FIG. 2 according to another exemplary embodiment of the present invention;

FIG. 7 is an enlarged cross-sectional view showing an E1 area of the optical film shown in FIG. 2 according to another exemplary embodiment of the present invention; and

FIGS. 8A to 8E are views showing a method of manufacturing the optical film shown in FIG. 6 according to an exemplary embodiment of the present invention.

### DETAILED DESCRIPTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

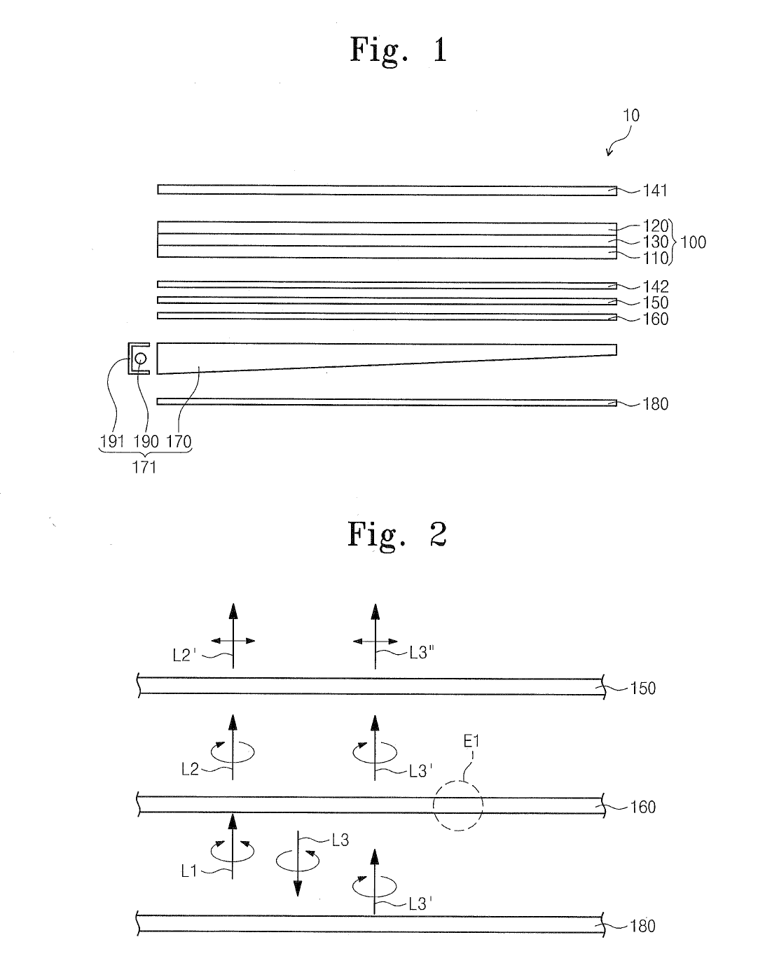

FIG. 1 is an exploded cross-sectional view showing a display apparatus according to an exemplary embodiment of the present invention, and FIG. 2 is a view showing an optical path of a light in a retardation plate, an optical film, and a reflection plate shown in FIG. 1.

Referring to FIG. 1, the display apparatus 10 includes a display panel 100 and a backlight unit 171 providing a light to the display panel 100.

The display panel 100 includes a first substrate 110, a second substrate 120 facing the first substrate 110, and a liquid crystal layer 130 disposed between the first and second substrates 110 and 120. The liquid crystal layer 130 may include twisted nematic liquid crystals, vertically aligned liquid crystals, or cholesteric liquid crystals.

Although not shown in FIG. 1, the first substrate 110 includes a plurality of pixels respectively having thin film transistors and pixel electrodes. In addition, the first substrate 110 includes a plurality of gate lines connected to the thin film transistors and a plurality of data lines connected to the thin film transistors. Data signals are applied to the thin film transistors through the data lines and gate signals area applied to the thin film transistors through the gate lines. The second substrate 120 includes a plurality of color filters and a common electrode. The display panel 100 controls the liquid crystal molecules included in the liquid crystal layer 130 in response to an electric field formed between the pixel electrode and the common electrode, thereby displaying an image.

The backlight unit 171 includes a light source 190 emitting the light, a light guide plate 170 guiding the light to the display panel 100, and a light source cover 191 covering the light source 190 to allow the light emitted from the light source 190 to travel to the light guide plate 170. The light source 190 may be a cold cathode fluorescent lamp (CCFL), an external electrode fluorescent lamp (EEFL), or a hot cathode fluorescent lamp (HCFL), etc.

The light guide plate 170 is disposed adjacent to the light source 190 to guide the light emitted from the light source 190 to the display panel 100. To this end, the light guide plate 170 has a thickness that gradually increases as it is closer to the light source 190.

The display apparatus 10 further includes a first polarizing plate 141 and a second polarizing plate 142 facing the first polarizing plate 141. Each of the first and second polarizing plates 141 and 142 transmits a light polarized in a specific direction and absorbs a light polarized in a direction substantially perpendicular to the specific direction. The first and second polarizing plates 141 and 142 may be formed of polyvinyl alcohol (PVA). A transmission axis of the first polarizing plate 141 may be substantially parallel to or perpendicular to a transmission axis of the second polarizing plate 142 according to the liquid crystal layer 130 employed to the display panel 100.

In FIG. 1, the first polarizing substrate 141 faces the second polarizing plate 142 while interposing the display panel 100 therebetween, but the display apparatus 10 does not need to include the second polarizing plate 142 according to embodiments.

Referring to FIGS. 1 and 2, an optical film 160 is disposed between the display panel 100 and the light guide plate 170. In addition, the display apparatus 10 further includes a reflection plate 180 facing the display panel 100 while interposing the optical film 160 therebetween to reflect the light incident thereto and a retardation plate 150 disposed between the display panel 100 and the optical film 160.

The optical film 160 transmits one of a right-circularly polarized light and a left-circularly polarized light and reflects the other one of the right-circularly polarized light and the left-circularly polarized light.

The reflection plate 180 includes a material having a high light reflectance and reflects the light incident thereto to the display panel 100. The reflection plate 180 may be a metal material having a superior light reflectance. The retardation plate 150 converts the circularly polarized light into the linearly polarized light. The circularly polarized light is changed into the linearly polarized light. In the present exemplary embodiment, the retardation plate 150 may be a quarter-wave plate.

The optical film 160, the reflection plate 180, and the retardation plate 180 effectively provides the light exiting from the light guide plate 170 to the display panel 100, thereby improving the light utilization efficiency. In detail, referring to FIG. 2, a first light, L1 emitted from the light source 190 and exiting through the light guide plate 170 travels to the optical film 160. Since the first light, L1 emitted from the light source 190 is not polarized, L1 includes left-circularly polarized light and right-circularly polarized light. The optical film 160 transmits one of the right-circularly polarized light and the left-circularly polarized light and reflects the other one of the right-circularly polarized light and the left-circularly polarized light.

Hereinafter, as shown in FIG. 2, the optical path of the light will be described on the assumption that the optical film 160 transmits the left-circularly polarized light and reflects the right-circularly polarized light.

Since the optical film 160 transmits the left-circularly polarized light of the first light L1, the left-circularly polarized light transmitted through the optical film 160 is provided to the retardation plate 150 as a second light L2. In addition, the optical film 160 reflects the right-circularly polarized light component of the first light L1, and thus the right-circularly polarized light reflected by the optical film 160 travels to the reflection plate 180 as a third light, L3.

The third light, L3 is reflected by the reflection plate 180 and provided again to the optical film 160. L3 is converted into a left-circularly polarized light when it is reflected by the reflection plate 180. That is, the phase of the third light, L3 is changed by 180 degrees when being reflected by the reflection plate 180. Accordingly, a right-circularly polarized light incident to the reflection plate 180 is converted into a left-circularly polarized light when being reflected by the reflection plate 180 and vice versa, and the third light L3 that is right-circularly polarized light is converted into a third light L3′ that is left-circularly polarized light.

The left-circularly polarized third light L3′ is transmitted through the optical film 160, and as a result the second light L2 and the third light L3′, originating from the first light L1, are transmitted through the optical film 160. Similarly, the right-circularly polarized light originating from L1 is transmitted through the optical film 160 or reflected and transmitted through the optical film 160. Thus, the light emitted from the light source 190 may be transmitted through the optical film 160 without loss of the light.

The second light L2 of the left-circularly polarized light and the third light L3′ of the left-circularly polarized light are provided to the retardation plate 150, so that the second light L2 and the third light L3′ are converted into the second light L2′ and the third light L3″ as the linearly polarized lights. The retardation film 150 may be the quarter-wave plate and change the phase of the light incident thereto by about 90 degrees, thereby changing the circularly polarized light into the linearly polarized light. Thus, the light transmitted through the retardation plate 150 becomes the light polarized in the specific direction, and the linearly polarized second and third lights L2′ and L3″ are provided to the display panel 100.

In other words, the optical film 160, the reflection plate 180, and the retardation plate 150 may polarize the light, which is not polarized, in the specific direction without the loss of the light and provide the polarized light to the display panel 100, thereby improving the light utilization efficiency.

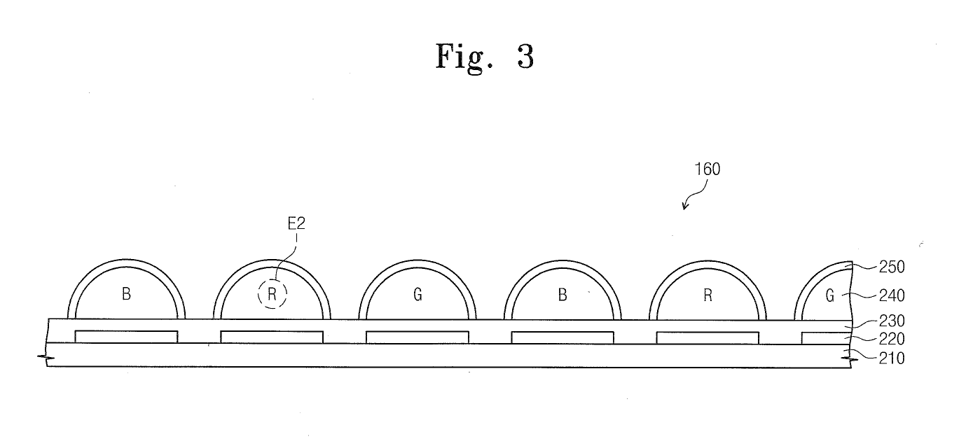

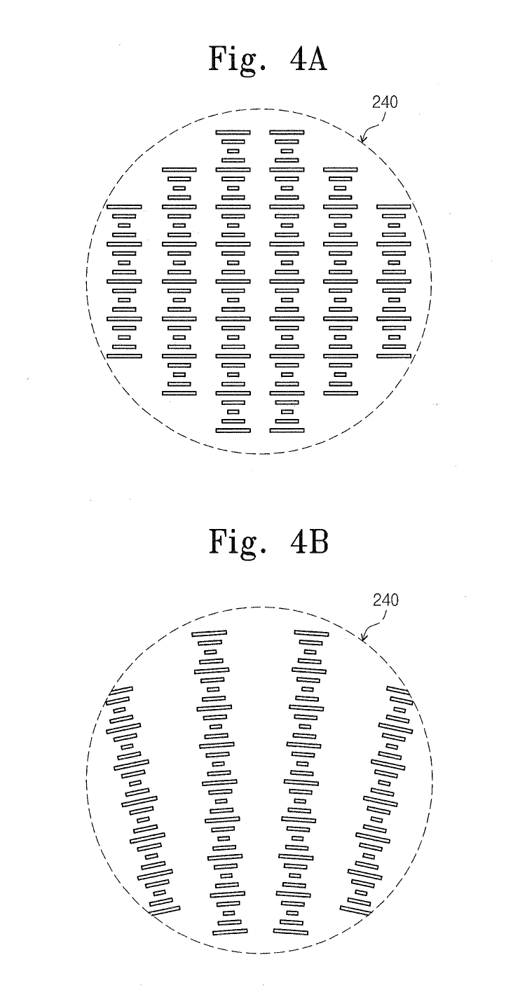

FIG. 3 is an enlarged cross-sectional view showing an E1 area of the optical film shown in FIG. 2 according to an exemplary embodiment of the present invention.

Referring to FIG. 3, the optical film 160 includes a base film 210, a plurality of thin film patterns 220 disposed on the base film 210, and cholesteric liquid crystals 240. The thin film patterns are disposed on the substrate so as to be separated from each other, i.e. not in direct contact with each other. In one embodiment, the cholesteric liquid crystals have a planar organization.

The base film 210 may be polyethylene terephthalate (PET), polyethylene naphthalate (PEN), fiber reinforced plastic (FRP), or glass. In addition, the base film 210 may include a hydrophobic material or a surface of the base film 210 may be subjected to modification treatment to have hydrophobic property.

The thin film patterns 220 are disposed on the base film 210 to be spaced apart from each other. The thin film patterns 220 may include a hydrophilic material, such as indium tin oxide (ITO), indium zinc oxide (IZO), etc.

An alignment layer 230 is disposed on the base film 210 to cover the thin film patterns 220 to define an alignment direction of the liquid crystals, and the alignment layer 230 may be vertically aligned or horizontally aligned.

The alignment layer 230 may be formed of at least one of eight materials (“a” to “h”) shown below, or binding materials of these eight materials.

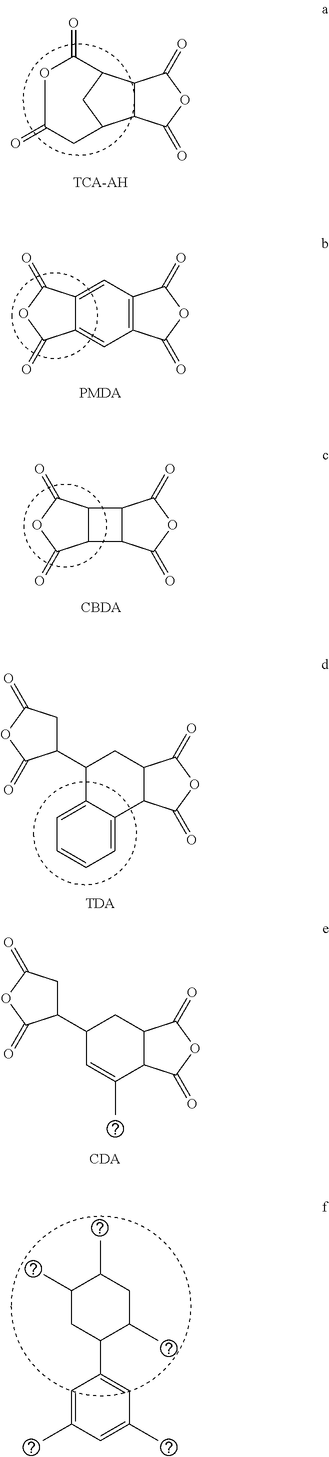

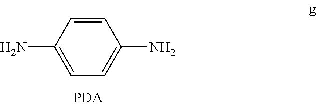

The cholesteric liquid crystals 240 are disposed on the alignment layer 230 so as to correspond in position to the thin film patterns 220. The cholesteric liquid crystals 240 may be formed in a left- or right-handed helical structure according to the amount of chiral dopant added to the cholesteric liquid crystals.

In detail, in the case that the cholesteric liquid crystals 240 are formed in a left-handed helical structure, the cholesteric liquid crystals 240 having the left-handed helical structure transmit the left-circularly polarized light and reflect the right-circularly polarized light. Alternatively, in the case when the cholesteric liquid crystals 240 are formed in a right-handed helical structure, the cholesteric liquid crystals 240 having a right-handed helical structure transmit the right-circularly polarized light and reflect the left-circularly polarized light.

The cholesteric liquid crystals 240 include a red cholesteric liquid crystal R representing a red color, a green cholesteric liquid crystal G representing a green color, and a blue cholesteric liquid crystal B representing a blue color. The red, green, and blue cholesteric liquid crystals R, G, and B transmit or reflect red, green, and blue lights, respectively. In detail, the red cholesteric liquid crystal R transmits one of a red right-circularly polarized light and a red left-circularly polarized light and reflects the other one of the red right-circularly polarized light and the red left-circularly polarized light. The green cholesteric liquid crystal G transmits one of a green right-circularly polarized light and a green left-circularly polarized light and reflects the other one of the green right-circularly polarized light and the green left-circularly polarized light. The blue cholesteric liquid crystal B transmits one of a blue right-circularly polarized light and a blue left-circularly polarized light and reflects the other one of the blue right-circularly polarized light and the blue left-circularly polarized light.

One of the red, green, and blue cholesteric liquid crystals R, G, and B is disposed on the alignment layer 230 to corresponding to one of the thin film patterns 220. In other words, each of the cholesteric liquid crystals 240 disposed on a corresponding thin film pattern of the thin film patterns 220 represents one of the red, green, and blue colors.

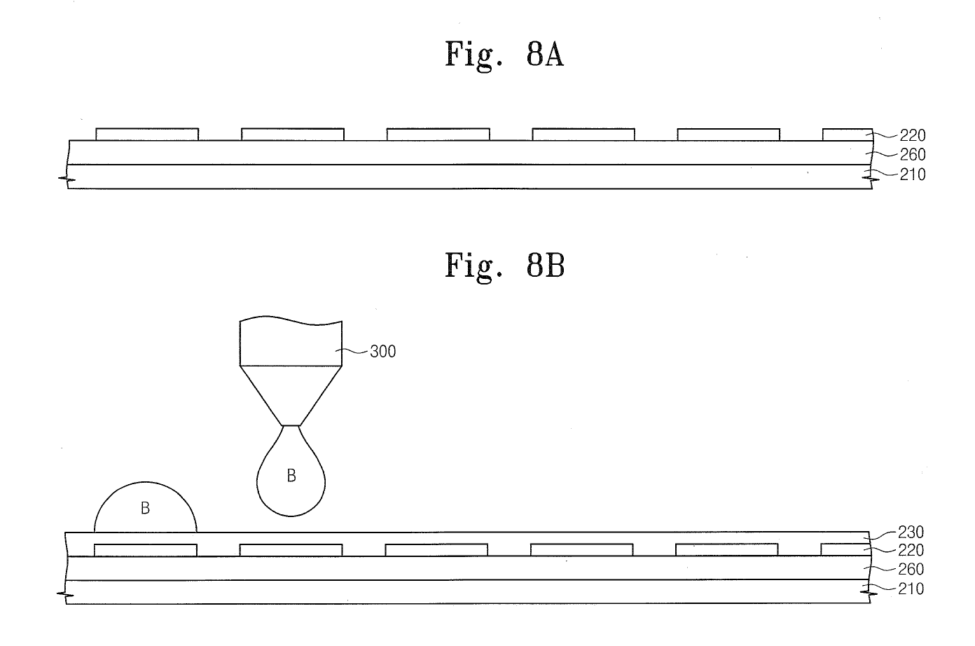

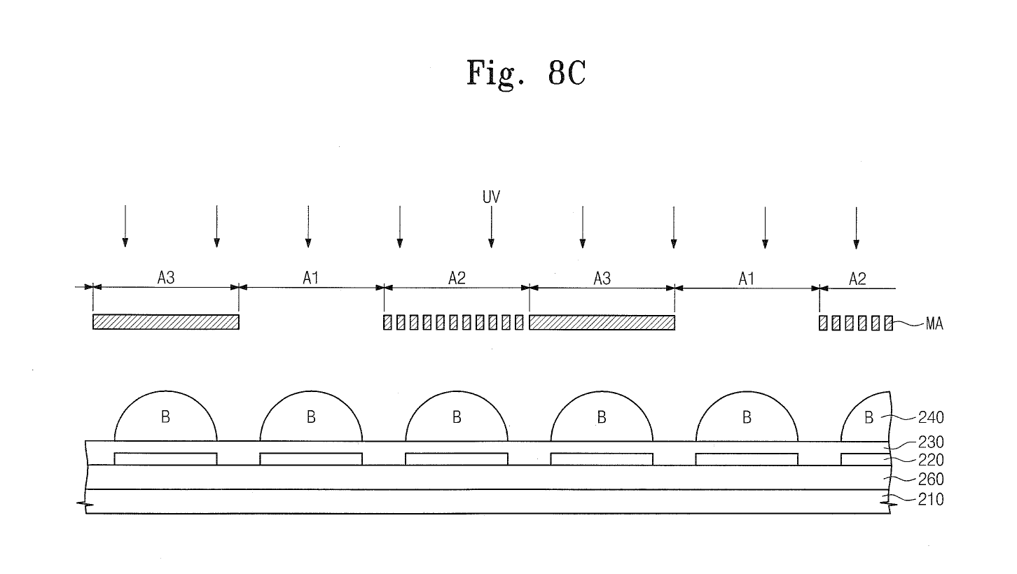

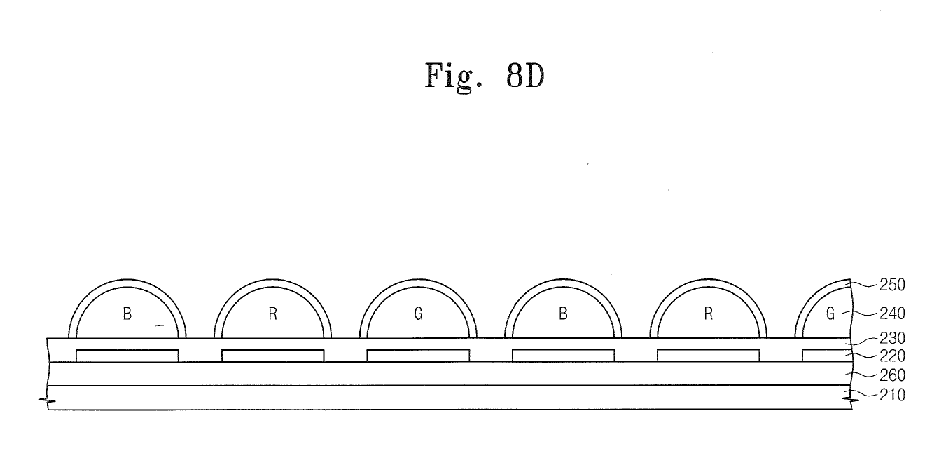

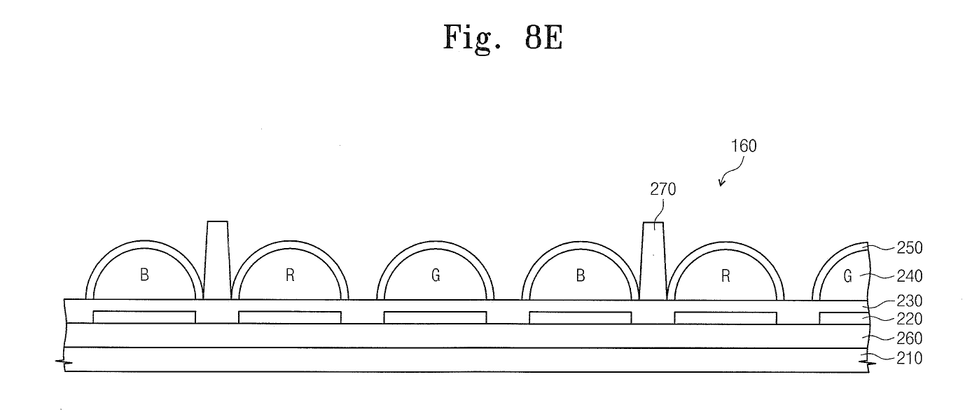

Since the cholesteric liquid crystals 240 have the hydrophilic property and portions of the alignment layer 230, on which the thin film patterns 220 are not formed, have the hydrophobic property, the cholesteric liquid crystals 240 may be concentrated on areas respectively corresponding to the thin film patterns 220 when the cholesteric liquid crystals 240 are formed on the alignment layer 230 by an inkjet method. The method of allowing the cholesteric liquid crystals 240 to represent the red, green, and blue colors will be described in detail with reference to FIGS. 8A to 8E.

The cholesteric liquid crystals 240 are obtained by adding at least one of chiral dopants as shown in Table 1 below into liquid crystal molecules having a positive dielectric anisotropy or a negative dielectric anisotropy.

TABLE 1

| compounds | Chemical structure |
|---|---|
| CN | 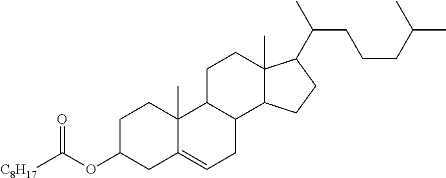 |
| CB-15 | 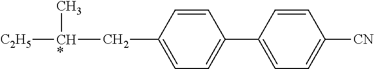 |
| S-811 | 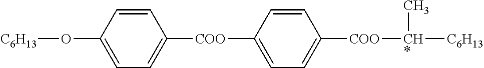 |
| Chiral A | 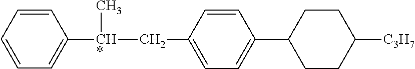 |
| Chiral B | 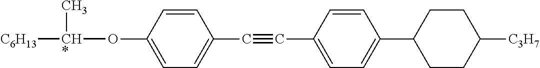 |
| Chiral C | 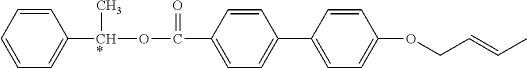 |
| Chiral D | 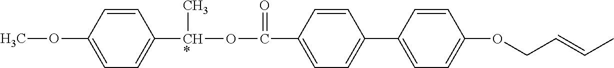 |
| Chiral E | 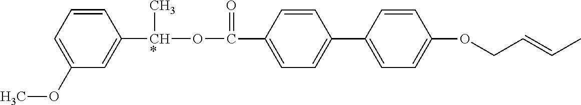 |
| Chiral F | 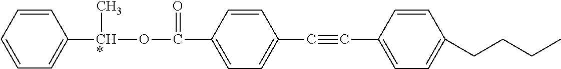 |
| Chiral G | 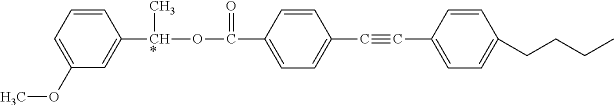 |

In addition, in order to change the pitch of the cholesteric liquid crystals 240 using ultraviolet light, a functional group, e.g., acrylate

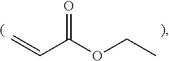

is included as a reactant to engage in a polymerization reaction at one end or both ends of the molecular structure of one or more of the dopants.

A capping layer 250 may be disposed on the cholesteric liquid crystals 240 to cover the cholesteric liquid crystals 240 and fix the cholesteric liquid crystals 240 to the alignment layer 230.

FIG. 4A is a view showing an E2 area of a cholesteric liquid crystal shown in FIG. 3 according to an exemplary embodiment of the present invention and FIG. 4B is a view showing an area E2 area of a cholesteric liquid crystal shown in FIG. 3 according to another exemplary embodiment of the present invention.

Referring to FIGS. 4A and 4B, the cholesteric liquid crystals 240 have a planar texture. The cholesteric liquid crystals 240 having the planar texture transmit or reflect the light having the specific wavelength of the light incident thereto. The cholesteric liquid crystals 240 are formed by adding the chiral dopant into a nematic liquid crystal, and thus the wavelength of the light reflected by or transmitting through the cholesteric liquid crystals 240 may be changed by controlling the amount of the chiral dopant added into the cholesteric liquid crystals 240.

Referring to FIGS. 3 and 4A, in the case that the alignment layer 230 is horizontally aligned, the cholesteric liquid crystals 240 have a nearly perfect planar texture in which axes of the cholesteric liquid crystals 240 are vertical to the alignment layer 230 as shown in FIG. 4A. In addition, referring to FIGS. 3 and 4B, in the case that the alignment layer 230 is vertically aligned, the cholesteric liquid crystals 240 have an imperfect planar texture in which axes of the cholesteric liquid crystals 240 are inclined against the alignment layer 230 as shown in FIG. 4B.

When the cholesteric liquid crystals 240 are formed in the perfect planar texture, a front visibility becomes high, but a side visibility becomes low. On the contrary, when the cholesteric liquid crystals 240 are formed in the imperfect planar texture, the front visibility becomes low, but the side visibility becomes high when compared to those of the perfect planar texture.

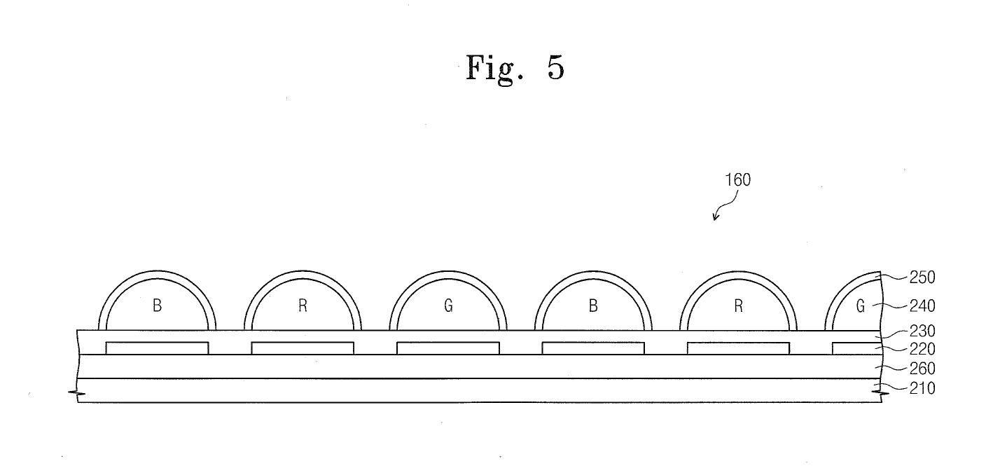

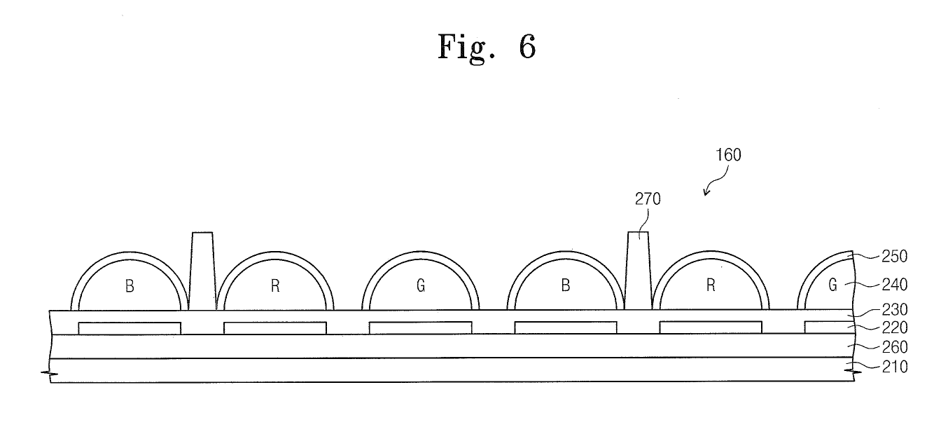

FIG. 5 is an enlarged cross-sectional view showing an E1 area of the optical film shown in FIG. 2 according to another exemplary embodiment of the present invention. In FIG. 6, the same reference numerals denote the same elements in FIG. 3, and thus detailed descriptions of the same elements will be omitted.

Referring to FIG. 5, the optical film 160 further includes a transparent layer 260 disposed between the base film 210 and the thin film patterns 220. The transparent layer 260 has the hydrophobic property and is formed of silicon nitride (SiNx).

That is, in the case that the base film 210 is difficult to have the hydrophobic property, the transparent layer 260 having the hydrophobic property may be further formed on the base film 210 as shown in FIG. 5.

Referring to FIGS. 3 and 5, the cholesteric liquid crystals 240 and the thin film patterns 220 have the hydrophilic property, but the cholesteric liquid crystals 240 may be treated so as to have the hydrophobic property and the thin film patterns 220 may be formed of a material having the hydrophobic property according to embodiments. In this case, the base film 210 or the transparent layer 260 may include a material having the hydrophilic property.

In detail, the cholesteric liquid crystals 240 and the thin film patterns 220 may have a first property corresponding to either the hydrophilic property or the hydrophobic property. In the case that the cholesteric liquid crystals 240 and the thin film patterns 220 have the first property, the base film 210 and the transparent layer 260 may have a second property corresponding to either the hydrophilic property or the hydrophobic property, which is different from the first property. Thus, when the cholesteric liquid crystals 240 and the thin film patterns 220 have the first property and the base film 210 and the transparent layer 260 have the second property, the cholesteric liquid crystals 240 may be disposed respectively corresponding to the thin film patterns 220 as shown in FIG. 5.

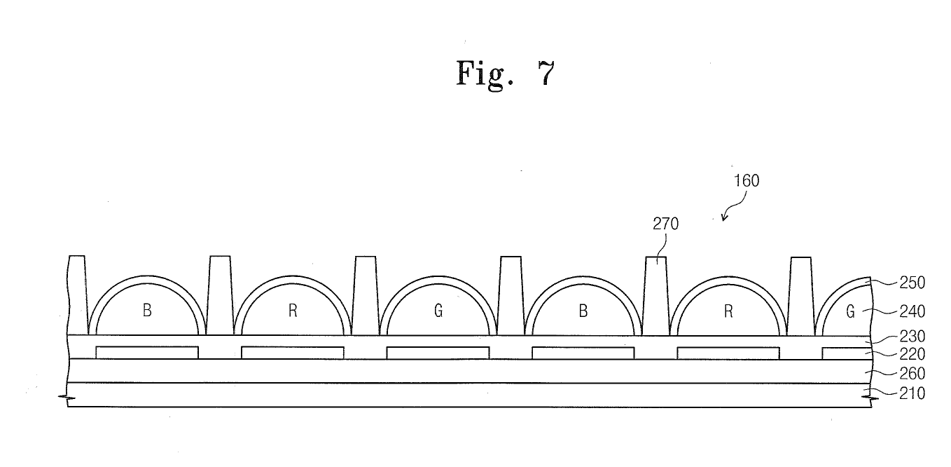

FIG. 6 is an enlarged cross-sectional view showing an E1 area of the optical film shown in FIG. 2 according to another exemplary embodiment of the present invention and FIG. 7 is an enlarged cross-sectional view showing an E1 area of the optical film shown in FIG. 2 according to another exemplary embodiment of the present invention.

Referring to FIG. 6, the optical film 160 further includes a plurality of barrier walls 270, each of which is disposed between the red cholesteric liquid crystal R and the blue cholesteric liquid crystal B adjacent to the red cholesteric liquid crystal R. In the present exemplary embodiment, since the red, green, and blue lights may form the white light, each of the barrier wall 270 may be disposed every three cholesteric liquid crystals 240 including each one of the red, green, and blue cholesteric liquid crystals R, G, and B to represent the white light.

Referring to FIG. 7, the optical film 160 may further include a plurality of barrier walls 270, each of which is disposed between two cholesteric liquid crystals adjacent to each other. As shown in FIG. 7, the barrier walls 270 are disposed in areas in which the cholesteric liquid crystals 240 are not formed when viewed in a plan view.

The barrier walls 270 are disposed in the areas in which the cholesteric liquid crystals 240 are not formed in a plan view, thereby preventing the movement of the cholesteric liquid crystals 240 and preventing the lights respectively transmitting the adjacent two cholesteric liquid crystals 240 from mixing with each other. Accordingly, the barrier walls 270 may improve the side visibility of the optical film 160.

FIGS. 8A to 8E are views showing a method of manufacturing the optical film shown in FIG. 6 according to an exemplary embodiment of the present invention.

Referring to FIG. 8A, after preparing the base film 210, the transparent layer 260 having the hydrophobic property is formed on the base film 210. The transparent layer 260 may be formed of silicon nitride. Then, the thin film patterns 220 are formed on the transparent layer 260 to be spaced apart from each other. The thin film patterns 220 include the material having the hydrophilic property, such as indium tin oxide (ITO), indium zinc oxide (IZO), etc.

Although not shown in FIG. 8A, when the thin film patterns 220 are formed of the metal material, such as indium tin oxide, indium zinc oxide, etc., the thin film patterns 220 may be formed on the transparent layer 260 by coating a metal material on the transparent layer 260 having the hydrophobic property, coating a photoresist on the metal material, and irradiating a light onto the photoresist to etch the phoresist.

Referring to FIG. 8B, the alignment layer 230 is formed on the transparent layer 260 and the thin film patterns 220. Then, the alignment layer 230 is aligned. The alignment layer 230 may be vertically aligned or horizontally aligned. That is, when the alignment layer 230 is horizontally aligned, the cholesteric liquid crystals provided on the alignment layer 230 may have the planar texture as shown in FIG. 4A. In addition, when the alignment layer 230 is vertically aligned, the cholesteric liquid crystals provided on the alignment layer 230 may have the planar texture as shown in FIG. 4B.

Then, the blue cholesteric liquid crystal B is formed on the alignment layer 230 to correspond to each of the thin film patterns 220. The blue cholesteric liquid crystal B may be formed on the alignment layer 230 by the inkjet method using an inkjet device 300.

Although not shown in FIG. 8B, the blue cholesteric liquid crystal B includes a reactive mesogen. The reactive mesogen reacts with the light incident thereto to reduce the chirality of the blue cholesteric liquid crystal B.

Referring to FIG. 8C, the light, e.g., an ultraviolet ray, is irradiated onto the blue cholesteric liquid crystals B using a mask MA that is patterned.

The mask MA includes a first area A1, a second area A2, and a third area A3. An opening is formed in the first area A1, a slit pattern is formed in the second area A2, and the opening or the slit pattern is not formed in the third area A3 to block the light incident thereto.

The first area A1 corresponds to an area with the blue cholesteric liquid crystal B that will be changed to the red cholesteric liquid crystal R, the second area A2 corresponds to an area with the blue cholesteric liquid crystal B that will be changed to the green cholesteric liquid crystal G, and the third area A3 corresponds to an area with the remaining blue cholesteric liquid crystals B.

In FIG. 8C, the mask MA employs a slit mask including the opening and the slit pattern to differently transmit the light, but various masks, e.g., a gradual mask, which differently transmits the light, may be used as the mask MA.

Referring to FIG. 8D, according to the amount of the light irradiated onto the blue cholesteric liquid crystals B including the reactive mesogen through the mask MA, a part of the blue cholesteric liquid crystals B is changed to the red cholesteric liquid crystal R, another part of the blue cholesteric liquid crystal B is changed to the green cholesteric liquid crystal G, and the remaining blue cholesteric liquid crystal B is maintained in the blue cholesteric liquid crystal.

In detail, the blue cholesteric liquid crystal disposed in the first area A1 among the blue cholesteric liquid crystals B is exposed to the largest amount of the light, so that the chirality of the blue cholesteric liquid crystal in the first area A1 is relatively largely reduced. As a result, the blue cholesteric liquid crystal in the first area A1 is changed to a long-pitch cholesteric liquid crystal, and thus the blue cholesteric liquid crystal in the first area A1 is changed to the red cholesteric liquid crystal R as shown in FIG. 8D.

In addition, the blue cholesteric liquid crystal disposed in the second area A2 among the blue cholesteric liquid crystals B is exposed to the amount of the light, which is smaller than the amount of the light passing through the first area A1, so that the reduction of the chirality of the blue cholesteric liquid crystal in the second area A2 is relatively small when compared to the reduction of the chirality of the blue cholesteric liquid crystal in the first area A1. As a result, the blue cholesteric liquid crystal in the second area A2 is changed to a cholesteric liquid crystal having a pitch between the red cholesteric liquid crystal R and the blue cholesteric liquid crystal B, and thus the blue cholesteric liquid crystal in the second area A2 is changed to the green cholesteric liquid crystal G as shown in FIG. 8D.

The blue cholesteric liquid crystal disposed in the third area A3 among the blue cholesteric liquid crystals B is not exposed to the light, so the blue cholesteric liquid crystal in the third area A3 is maintained in the blue cholesteric liquid crystal.

The capping layer 250 may be further formed on the cholesteric liquid crystals 240 to cover the cholesteric liquid crystals 240. The capping layer 250 prevents the movement of the cholesteric liquid crystals 240 and fixes the cholesteric liquid crystals 240 to the optical film 160. The capping layer 250 may include parlyrene and may be formed on the cholesteric liquid crystals 240 by a chemical vapor deposition method.

Referring to FIG. 8E, the barrier walls 270 may be formed on the alignment layer 230 to allow each of the barrier walls 270 to be disposed between two cholesteric liquid crystals adjacent to each other, to thereby isolate the two cholesteric liquid crystals from each other. The barrier walls 270 may prevent the cholesteric liquid crystals from moving to adjacent area. In addition, the barrier walls 270 may prevent the light transmitting through the optical film 160 from traveling to a direction inclined with respect to a normal line of the optical film 160, thereby improving the side visibility of the optical film 160.

In FIG. 8E, the barrier walls 270 are formed on the alignment layer 230 after the capping layer 250 is formed, but the barrier walls 270 may be formed on the alignment layer 230 before forming the capping layer 250 or coating the cholesteric liquid crystals 240 on the alignment layer 230.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An optical film comprising:
a base film;
a plurality of thin film patterns disposed on the base film to be spaced apart from each other, the thin film patterns having a first property corresponding to one of a hydrophilic property and a hydrophobic property; and
a plurality of cholesteric liquid crystals having the first property and respectively disposed on the thin film patterns so as to transmit one of a right-circularly polarized light and a left-circularly polarized light and reflect the other one of the right-circularly polarized light and the left-circularly polarized light.

2. The optical film of claim 1, wherein the base film has a second property selected from a hydrophilic property and a hydrophobic property, wherein the second property is different from the first property.

3. The optical film of claim 2, wherein the thin film patterns comprise at least one of indium tin oxide or indium zinc oxide.

4. The optical film of claim 1, further comprising a transparent layer disposed between the base film and the thin film patterns and having a second property selected from a hydrophilic property and a hydrophobic property, wherein the second property is different from the first property.

5. The optical film of claim 4, wherein the transparent layer comprises silicon nitride.

6. The optical film of claim 1, further comprising a capping layer that covers the cholesteric liquid crystals and fixes the cholesteric liquid crystals.

7. The optical film of claim 1, further comprising an alignment layer disposed between the thin film patterns and the cholesteric liquid crystals to control an alignment direction of liquid crystals included in the cholesteric liquid crystals.

8. The optical film of claim 7, wherein the alignment layer is horizontally aligned and the liquid crystals included in the cholesteric liquid crystals have a planar organization.

9. The optical film of claim 8, wherein the alignment layer is vertically aligned and the liquid crystals included in the cholesteric liquid crystals have an imperfect planar organization.

10. The optical film of claim 1, further comprising a plurality of barrier walls, each of which is disposed between two thin film patterns adjacent to each other to separate the cholesteric liquid crystals disposed on each of the two film patterns.

11. The optical film of claim 1, wherein the cholesteric liquid crystals comprise:
a red cholesteric liquid crystal transmitting one of a red right-circularly polarized light and a red left-circularly polarized light and reflecting the other one of the red right-circularly polarized light and the red left-circularly polarized light;
a green cholesteric liquid crystal transmitting one of a green right-circularly polarized light and a green left-circularly polarized light and reflecting the other one of the green right-circularly polarized light and the green left-circularly polarized light; and
a blue cholesteric liquid crystal transmitting one of a blue right-circularly polarized light and a blue left-circularly polarized light and reflecting the other one of the blue right-circularly polarized light and the blue left-circularly polarized light.

12. The optical film of claim 11, wherein each and every one of the cholesteric liquid crystals disposed on a corresponding thin film pattern of the thin film patterns are red cholesteric liquid crystals, green cholesteric liquid crystals, or blue cholesteric liquid crystals.

13. A display apparatus comprising:
a light source unit emitting a light;
a display panel receiving the light and controlling a transmittance of the light to display an image; and
an optical film disposed between the light source unit and the display panel, wherein the optical film comprises:
a base film;
a plurality of thin film patterns disposed on the base film to be spaced apart from each other, the thin film patterns having a first property selected from a hydrophilic property and a hydrophobic property; and
a plurality of cholesteric liquid crystals having the first property and respectively disposed on the thin film patterns to transmit one of a right-circularly polarized light and a left-circularly polarized light and reflect the other one of the right-circularly polarized light and the left-circularly polarized light.

14. The display apparatus of claim 13, further comprising a transparent layer disposed between the base film and the thin film patterns and having a second property selected from a hydrophilic property and a hydrophobic property, wherein the second property is different from the first property.

15. The display apparatus of claim 13, further comprising a reflection plate disposed to face the display panel, wherein the optical film is disposed therebetween to reflect the light incident thereto.

16. The display apparatus of claim 13, further comprising a retardation plate disposed between the display panel and the optical film to convert the right-circularly polarized light or the left-circularly polarized light to a linearly polarized light.

17. A method of manufacturing an optical film, comprising:
forming a plurality of thin film patterns on a base film to be spaced apart from each other, the thin film patterns having a first property corresponding to one of a hydrophilic property and a hydrophobic property;
forming cholesteric liquid crystals on the thin film patterns, respectively, the cholesteric liquid crystals having a reactive mesogen and representing a blue color; and
non-uniformly irradiating a light onto the cholesteric liquid crystals to change a part of the cholesteric liquid crystals to a red cholesteric liquid crystal representing a red color or a green cholesteric liquid crystal representing a green color.

18. The method of claim 17, wherein the cholesteric liquid crystals transmit one of a right-circularly polarized light and a left-circularly polarized light and reflect the other one of the right-circularly polarized light and the left-circularly polarized light.

19. The method of claim 17, further comprising forming a transparent layer on the base film to have a second property selected from a hydrophilic property and the hydrophobic property, wherein the second property is different from the first property.

20. The method of claim 17, further comprising forming a capping layer to cover and fix the cholesteric liquid crystals.
